(19) United States
(12) Patent Application Publication
(10) Pub. No.: US 2026/0010769 A1
(43) Pub. Date: Jan. 8, 2026

(54) GENERATING CHAIN-OF-THOUGHT PROMPT TEMPLATES USING MULTI-MODAL LARGE LANGUAGE MODELS FOR TABULAR DATA MATCHING

(71) Applicant: SAP SE, Walldorf (DE)

(72) Inventors: Rajesh Vellore Arumugam, Singapore (SG); Vaishnavi Inbanathan, Singapore (SG); Prawira Putra Fadjar, Singapore (SG); Kham Sian Mung, Singapore (SG); Yi Quan Zhou, Singapore (SG)

(21) Appl. No.: 18/762,792

(22) Filed: Jul. 3, 2024

(51) Int. Cl. G06N 3/0475

(52) U.S. Cl. CPC G06N 3/0475

(57) ABSTRACT

Methods, systems, and computer-readable storage media for receiving use case data descriptive of a use case that includes tabular data matching, the use case data including process data, task data, table schema data, and a set of few-shot examples, populating a CoT extraction prompt template using the use case data to provide a CoT extraction prompt, prompting a LLM using the CoT extraction prompt, receiving, from the LLM, a CoT script responsive to the CoT extraction prompt, generating an inference prompt template using the CoT script, and deploying the inference prompt template for production inference.

### BACKGROUND

In the field of artificial intelligence (AI), so-called generative AI (GAI) has recently seen an explosion in popularity. GAI can be described as including so-called foundation models that generate content based on training data. For example, foundation models can include large language models (LLMs), which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of AI use cases when compared to conventional machine learning (ML) models. However, integrating LLMs into enterprise platforms is a non-trivial task, as LLMs can present various technical challenges and can have disadvantages that have to be managed.

### SUMMARY

Implementations of the present disclosure are directed to chain-of-thought (CoT) prompting of large language models (LLMs) for tabular data matching by automatic generation of CoT scripts for prompt templates. More particularly, implementations of the present disclosure include automatically generating CoT scripts for generic tabular data matching tasks using a LLM.

In some implementations, actions include receiving use case data descriptive of a use case that includes tabular data matching, the use case data including process data, task data, table schema data, and a set of few-shot examples, populating a CoT extraction prompt template using the use case data to provide a CoT extraction prompt, prompting a LLM using the CoT extraction prompt, receiving, from the LLM, a CoT script responsive to the CoT extraction prompt, generating an inference prompt template using the CoT script, and deploying the inference prompt template for production inference. Other implementations of this aspect include corresponding systems, apparatus, and computer programs, configured to perform the actions of the methods, encoded on computer storage devices.

These and other implementations can each optionally include one or more of the following features: production inference includes populating the inference prompt template with production data including a set of tables to provide an inference prompt, prompting the LLM using the inference prompt, receiving an inference result from the LLM, and executing at least one task of a workflow in response to the inference result; the tabular data matching includes matching a query entity represented in a row of a first table to one or more target entities represented in respective rows of a second table; deploying the inference prompt template for production inference is executed in response to determining that the inference prompt template is valid; the inference prompt template is determined to be valid in response to determining that an accuracy of results generated using the inference prompt template meets a threshold accuracy; the table schema data describes fields of columns of each of a first table and a second table storing records that are to be matched by the LLM; and at least a portion of the use case data includes an image representative of the use case.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture in accordance with implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to chain-of-thought (CoT) prompting of large language models (LLMs) for tabular data matching by automatic generation of CoT scripts for prompt templates. More particularly, implementations of the present disclosure include automatically generating CoT scripts for generic tabular data matching tasks using a LLM.

Implementations can include actions of receiving use case data descriptive of a use case that includes tabular data matching, the use case data including process data, task data, table schema data, and a set of few-shot examples, populating a CoT extraction prompt template using the use case data to provide a CoT extraction prompt, prompting a LLM using the CoT extraction prompt, receiving, from the LLM, a CoT script responsive to the CoT extraction prompt, generating an inference prompt template using the CoT script, and deploying the inference prompt template for production inference.

To provide further context for implementations of the present disclosure, and as introduced above, in the field of artificial intelligence (AI), machine learning (ML) enables ML models to be trained to perform specific tasks. It can be noted that use of ML models necessarily expends technical resources (processors, memory, bandwidth) for training, storing, and maintaining ML models. In the context of implementations of the present disclosure, example tasks can include matching data between tables, which can be referred to as tabular data matching. This can include, for example, matching a query entity recorded in a first data table to one or more target entities recorded in a second data table. In some examples, each query entity is recorded in a row of the first table where columns record data of respective fields that are descriptive of a respective query entity. Similarly, in some examples, each target entity is recorded in a row of the second table where columns record data of respective fields that are descriptive of a respective target entity.

To improve performance of a software system that is tasked with tabular data matching, a ML model can be trained using historical matches between query entities and target entities to enable the ML model to performing data matching tasks. For example, through training, the ML model learns patterns in the data that indicate matches between query entities and target entities across multiple tables. However, such ML models, are specific to the historical data that they are trained on. For example, a first ML model can be trained on historical data of a first enterprise and a second ML model can be trained on historical data of a second enterprise. The first ML model cannot be used for accurate matching tasks of the second enterprise and vice-versa. As such, a data matching system has to train, store, execute, and maintain multiple ML models for each enterprise that leverages the data matching system. This consumes a significant amount of technical resources (processors, memory, bandwidth) to provision the data matching system.

Further, data can evolve over time, which results in a ML model becoming obsolete in terms of, for example, its performance degrading over time. For example, a ML model can be trained on historical data, then deployed for inference. However, over time, the data input to the ML model for inference can evolve and become different than the historical data that the ML model was trained on. In view of this the ML model must be updated to account for changes and ensure accuracy of the ML model. This requires periodic retraining of the ML model, which consumes a significant amount of technical resources (processors, memory, bandwidth). The periodic retraining is multiplied given that multiple ML models are provisioned for multiple enterprises.

In the field of AI, so-called generative AI (GAI) has recently seen an explosion in popularity. GAI can be described as including so-called foundation models that generate content based on training data. For example, foundation models can include LLMs, which are a form of GAI that can be used to generate text for a variety of use cases. LLMs have demonstrated remarkable proficiency as general-purpose agents (e.g., chatbots) with extensive capacities for text generation, classification, detection, and the like. For enterprises, these capabilities significantly speed up iterations of AI use cases when compared to conventional machine learning (ML) models, such as the task-specific ML models introduced above (e.g., a ML model for tabular data matching). Further, use of a LLM obviates the need for multiple ML models that are enterprise-specific, as well as training, maintaining, and storing the ML models.

However, integrating LLMs into enterprise platforms is a non-trivial task. One reason for this is that LLMs can present various technical challenges and can have disadvantages that have to be managed. For example, LLMs are generally trained and are not specific to any particular task or even domain. As such, the effectiveness of an LLM in performing specific tasks, such as tabular data matching, is predominantly reliant on prompts, which are the input to the LLM. Well-constructed and detailed prompts enable the LLM to provide higher quality responses. However, prompts can be relatively complex for many enterprise-level use cases. For example, prompts can involve extensive directives, sophisticated instructions, and input data to provide context for the LLM.

In many use cases, prompts that are to be input to a LLM are generated using prompt templates. In some examples, prompt templates include static input and dynamic input. Here, the static input is the same for each prompt and each invocation of the LLM (each time the LLM is prompted), and the dynamic input includes data dictated by user interaction for each invocation of the LLM. That is, the dynamic input can change for each prompt and each invocation of the LLM. Achieving the desired output from the LLM responsive to the prompts necessitates a high degree of precision.

CoT prompting is a prompt engineering technique that aims to improve the performance of generally trained, non-domain specific LLMs on tasks requiring logic, calculation and decision-making by structuring the prompt in a way that mimics human reasoning. More particularly, CoT prompting is a prompting method used to encourage LLMs to not only output an answer, but also explain to the LLM the steps to be followed to derive the answer. However, CoT scripts within prompt templates are use-case specific and must be crafted for the specific use case, such as tabular data matching, which is a resource-consuming task. For example, CoT scripts of prompt templates are provisioned through a time- and resource-intensive process of trial-and-error by repetitively prompting a LLM until the LLM, using the CoT script, achieves the desired results. This process also demands a detailed knowledge of the specific use case and, as such, cannot be performed by non-expert users.

In view of the above context, implementations of the present disclosure provide for automatic generation and optimization of CoT scripts used in prompt templates for prompting LLMs to perform tabular data matching tasks. As described in further detail herein, implementations of the present disclosure leverage the LLMs to generate prompt templates that include CoT scripts for tabular data matching.

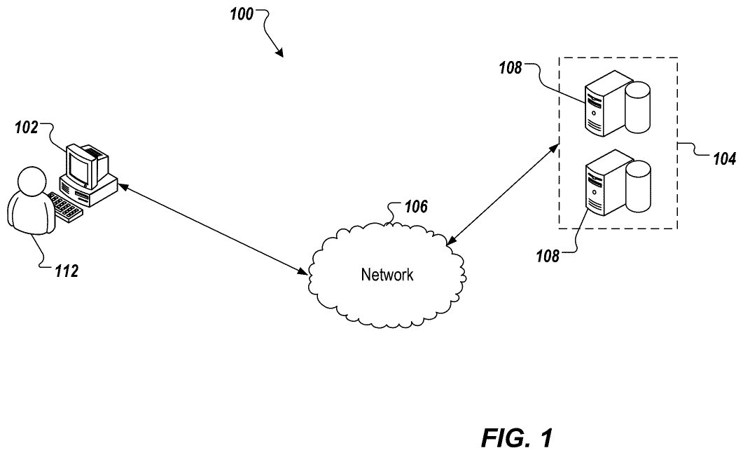

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106). In accordance with implementations of the present disclosure, and as noted above, the server system 104 can host a prompt template generation system for generating prompt templates that include CoT scripts to prompt LLMs for tabular data matching tasks.

Implementations of the present disclosure are described in further detail herein with reference to an example, non-limiting use case, which includes tabular data matching to match delivery transactions with packaging return transactions. For example, customers can purchase a product from a supplier that is delivered in returnable packaging and, after the customer receives the product, the customer returns the packaging to the supplier. In the example use case, deliveries are recorded in a delivery transaction table and returns are recorded in a packaging return transaction table. In tabular data matching, matches can be performed between records in the delivery transaction table and records in the packaging return transaction table to identify packaging that has been returned and packaging that has not been returned. Although implementations of the present disclosure are described with reference to the example use case, it is contemplated that implementations of the present disclosure can be used with any appropriate use case.

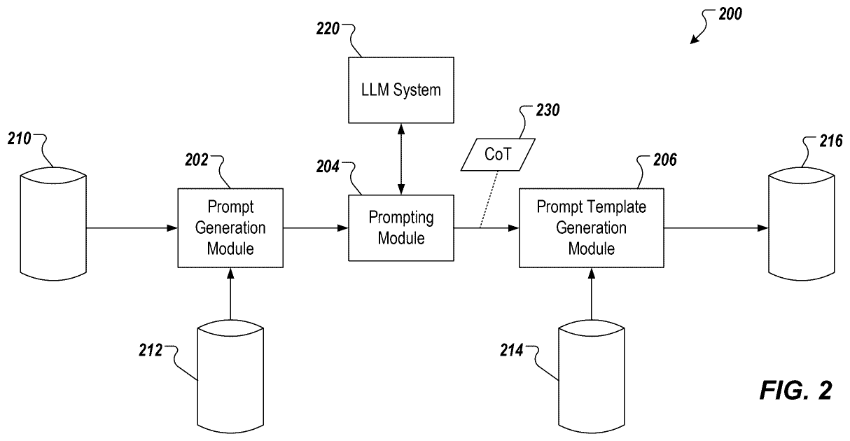

FIG. 2 depicts an example conceptual architecture 200 in accordance with implementations of the present disclosure. In the depicted example, the conceptual architecture 200 depicts at least a portion of prompt template generation system that includes a prompt generation module 202, a prompting module 204, a prompt template generation module 206, a CoT extraction prompt template store 210, a use case data store 212, a partial prompt template store 214, and an inference prompt template store 216. As described in further detail herein, the prompt template generation system of the present disclosure interacts with a LLM system 220 to provide a CoT script 230 for use in a prompt template. In some examples, the LLM system 220 executes a LLM (e.g., ChatGPT) that is prompted to generate CoT scripts as described in further detail herein. In some examples, the LLM is a multi-modal LLM that can ingest multiple modes of input (e.g., text, images, audio, video). In some examples, prompt templates generated by the prompt template generation system of the present disclosure can be used to prompt the LLM system 220 for tabular data matching tasks.

In further detail, the prompt generation module 202 generates a CoT generation prompt. In some examples, the prompt generation module 202 receives a CoT extraction prompt template from the CoT extraction prompt template store 210 and use case data from the use case data store 212. In some examples, CoT extraction prompt template includes placeholders that are populated with use case data. Example placeholders can include a process placeholder, a task placeholder, a data schema placeholder, and a few-shot examples placeholder. In some examples, the use case data retrieved from the use case data store 212 is responsive to user input to the prompt generation module 202 (e.g., user input that indicates a use case and use case data of the use case is retrieved). The following is a non-limiting example of a CoT extraction prompt template:

The picture below depicts a business process or flow and the
corresponding Business problem
{url_of_image}
Table 1 represents the package return transaction and Table 2
represents the delivery transaction. Below shows examples of
matching items between rows in Table 1 and rows in Table 2 in
csv format. Given the Business Process, Business problem, list
the steps used to arrive at the matching conclusion expressing
it as a Chain of thought reasoning steps. Do not output the
reference to the examples in the steps:
Example 1:
{Table 1}
{Table 2}
Example 2:
{Table 1}
{Table 2}
Example 3:
{Table 1}
{Table 2}

In some implementations, the use case data includes process data, task data, table schema data, and few-shot examples. In some examples, the process data is descriptive of a process that is performed for an enterprise and provides context with details of the subjects and/or actors involved, actions performed, and any constraints and/or limitations on the process. For example, and with reference to the example use case, the process data can be descriptive of the process of delivery and return of packaging, as described above. In some examples, the task data is descriptive of a task that is to be performed. For example, and with reference to the example use case, the task data can be descriptive of the task of matching records of the delivery transaction table to records of the packaging return transaction table.

In some examples, the table schema data is descriptive of the data schema used for recording transactions in respective tables. For example, for each table that is to be used in a matching task, the table schema data can describe what types of records are provided in each row and fields of columns. With reference to the example use case, the table schema data can describe that rows in the delivery transaction table are deliveries to customers, a RETURNABLEACCOUNTNUMBER column records free-form text denoting an account identifier, a VENDORNO column records free-form text denoting vendor identifier, CUSTOMERNO column records free-form text denoting a customer identifier, etc., and a PACKAGING_ID column records free-form text denoting a packaging identifier, and that rows in the packaging return transaction table are returns from customers, a RETURNABLEACCOUNTNUMBER column records free-form text denoting an account identifier, a VENDORCODE column records free-form text denoting vendor identifier, CUSTOMERNO column records free-form text denoting a customer identifier, etc.

In some examples, the few-shot examples are each an example of a successful match of records between tables. The conditions for a potential match could also be provided with each few-shot example. The few-shot examples are used for few-shot learning of the LLM executed by the LLM system 220. Here, few-shot learning (also referred to as in-context learning and/or few-shot prompting) is a prompting technique that enables the LLM to process examples before attempting a task. Here, the task is tabular data matching and the examples are records of disparate tables that had previously been matched.

In some examples, at least a portion of the use case data is provided as text data. For example, the process data can include a textual description of a process that underlies the use case. In this example, the process data can be provided as the following example text data:

A customer can purchase products from a supplier. In response
to the purchase, the supplier delivers the products in
returnable packaging and records the delivery in a delivery
transaction table. After the customer receives the products,
the customer returns the packaging to the supplier. The
supplier receives the packaging and records the return in a
package return transaction table.

In some examples, at least a portion of the use case data is provided as image data. For example, the process data can include an image that depicts a process that underlies the use case (e.g., a flowchart). Continuing with the non-limiting example above use case data can be represented in an image that depicts a flowchart including steps of: Customer Purchase, Supplier Delivery, Record Delivery In Delivery Transaction Table, Customer Receives Product, Customer Returns Packaging, Supplier Receives Packaging, and Supplier Records Return in Package Return Transaction Table.

In some implementations, the prompt generation module 202 provides the CoT generation prompt to the prompting module 204, which prompts the LLM of the LLM system 220. For example, the prompting module 204 can make a call to an application programming interface (API), the call including the CoT generation prompt. In some examples, the LLM of the LLM system 220 is a multi-modal LLM that can ingest and process multiple modes of input. In this manner, the LLM can process use case data provided as text and/or images of the CoT generation prompt.

The LLM system 220 processes the CoT generation prompt and returns the CoT script 230 in response to the CoT generation prompt. With continued reference to the example use case, an example CoT script can be provided as:

| | |
|---|---|
| 1. | Identify the key fields in both Table 1 and Table 2 that |
| | can be used to match the delivery transaction with the |
| | package return transaction. These fields include the |
| | RETURNABLEACCOUNTNUMBER, VENDORNO/CUSTOMERNO, |
| | DELIVERYDOCUMENTNUMBER, and QUANTITY. |
| 2. | Compare the RETURNABLEACCOUNTNUMBER from Table 1 with the |
| | RETURNABLEACCOUNTNUMBER in Table 2 to ensure they match, |
| | indicating that the returnable packaging account is the |
| | same for both transactions. |
| 3. | Check the VENDORNO in Table 1 and compare it with the |
| | VENDORCODE in Table 2 to confirm that the vendor involved |
| | in the delivery transaction is the same as the one |
| | involved in the package return transaction. |
| 4. | Match the DELIVERYDOCUMENTNUMBER and |
| | DELIVERYDOCUMENTITEMNO from Table 1 with the DELIVERYNOTE |
| | and DELIVERYNOTEITEMNUMBER in Table 2 to ensure that the |
| | specific delivery transaction corresponds to the specific |
| | package return transaction. |
| 5. | Verify that the QUANTITY in Table 1 matches the |
| | RETURNABLEMATERIALQUANTITY and DELIVERYNOTEQUANTITY in |
| | Table 2 to confirm that the amount of material delivered |
| | is the same as the amount returned. |
| 6. | Ensure that the TRANSACTIONTYPE in Table 1 aligns with |
| | the MOVEMENTTYPE in Table 2, indicating that the type of |
| | transaction (delivery or return) is consistent between |
| | the two tables. |
| 7. | Confirm that the LOCATIONTYPE, LOCATIONID, PARTNERTYPE, |
| | and PARTNERID are consistent between both tables, |
| | indicating that the location and partner details for the |
| | delivery and return are the same. |
| 8. | Once all the key fields match between the two tables, |
| | conclude that the delivery transaction and the package |
| | return transaction are correctly matched. 9. Repeat the |
| | process for each row in Table 1 and Table 2 to match all |
| | delivery transactions with their corresponding package return |
| | transactions. |

In some implementations, the prompt template generation module 206 receives partial prompt template corresponding to the use case from the partial prompt template store 214. In some examples, the prompt template generation module 206 populates the partial prompt template with the CoT 230 to generate the inference prompt template and stores the inference prompt template in the inference prompt template store 216. With continued reference to the example use case, an example inference prompt template can be provided as:

template=”””

| | |
|---|---|
| 1. | Identify the key fields in both Table 1 and Table 2 that |
| | can be used to match the delivery transaction with the |
| | package return transaction. These fields include the |
| | RETURNABLEACCOUNTNUMBER, VENDORNO/CUSTOMERNO, |
| | DELIVERYDOCUMENTNUMBER, and QUANTITY. |
| 2. | Compare the RETURNABLEACCOUNTNUMBER from Table 1 with the |
| | RETURNABLEACCOUNTNUMBER in Table 2 to ensure they match, |
| | indicating that the returnable packaging account is the |
| | same for both transactions. |
| 3. | Check the VENDORNO in Table 1 and compare it with the |
| | VENDORCODE in Table 2 to confirm that the vendor involved |
| | in the delivery transaction is the same as the one |
| | involved in the package return transaction. |
| 4. | Match the DELIVERYDOCUMENTNUMBER and |
| | DELIVERYDOCUMENTITEMNO from Table 1 with the DELIVERYNOTE |
| | and DELIVERYNOTEITEMNUMBER in Table 2 to ensure that the |
| | specific delivery transaction corresponds to the specific |
| | package return transaction. |
| 5. | Verify that the QUANTITY in Table 1 matches the |
| | RETURNABLEMATERIALQUANTITY and DELIVERYNOTEQUANTITY in |
| | Table 2 to confirm that the amount of material delivered |
| | is the same as the amount returned. |
| 6. | Ensure that the TRANSACTIONTYPE in Table 1 aligns with |
| | the MOVEMENTTYPE in Table 2, indicating that the type of |
| | transaction (delivery or return) is consistent between |
| | the two tables. |
| 7. | Confirm that the LOCATIONTYPE, LOCATIONID, PARTNERTYPE, |
| | and PARTNERID are consistent between both tables, |
| | indicating that the location and partner details for the |
| | delivery and return are the same. |

Once all the key fields match between the two tables, conclude
that the delivery transaction and the package return
transaction are correctly matched. 9. Repeat the process for
each row in Table 1 and Table 2 to match all delivery
transactions with their corresponding package return
transactions.
Output only the JSON string showing the column ... from Table 1
and >>> from Table 2 for all of the matched items. Following
are the contents of Table 1 and Table 2 in csv format
Table1:
{table1}
Table2:
{table2}
Output:
”””

In some implementations, before being released for production use, the inference prompt template can be validated. In some examples, validation can include executing inference using the inference prompt populated with validation data to provide an inference prompt. The validation data can be provided as historical data that includes a set of tables and a set of results, the set of results including query entity and target entity matches (e.g., query entity, target entity pairs) for the set of tables. The LLM can be prompted to execute tabular data matching that is responsive to an inference prompt that includes the CoT script (generated by the LLM) and the set of tables, the LLM providing a response set, the response set including query entity and target entity matches (e.g., query entity, target entity pairs).

In some examples, the matches from the set of results provided with the validation data are compared to the matches of the response set to determine whether the inference prompt template is valid. For example, an accuracy of the inference prompt template can be determined by comparing the matches from the set of results provided with the validation data to the matches of the response set. Here, accuracy can be determined as the number of matches of the response set that correspond to matches of the set of results. The accuracy can be compared to a threshold accuracy (e.g., 90%, 95%, 100%) to determine whether the accuracy meets (e.g., is equal to or greater than) the threshold accuracy. If the accuracy meets the threshold accuracy, the inference prompt template is determined to be valid. If the accuracy does not meet the threshold accuracy, the inference prompt template is determined to not be valid.

In some examples, if the inference prompt template is determined to be valid (e.g., the accuracy meets the threshold accuracy), the inference prompt template is released for production inference. In some examples, if the inference prompt template is determined not to be valid (e.g., the accuracy does not meet the threshold accuracy), the CoT script can be regenerated by the LLM. For example, a revised CoT extraction prompt can be generated using a set of few-shot examples that is different than the set of few-shot examples used in a previous iteration. The CoT script is generated, as described above, and validation is again performed before release for production inference.

In some implementations, production inference includes using the inference prompt template in an enterprise workflow to perform tabular data matching. For example, the inference prompt template can be populated with production data (e.g., data tables) to provide an inference prompt for tabular data matching by the LLM. Here, the production data is data that has not been previously processed for tabular data matching. The LLM returns a response to the inference prompt, which response is used in downstream tasks of the enterprise workflow (e.g., clearing packages that have been returned, following up with customers on packages that have not been returned).

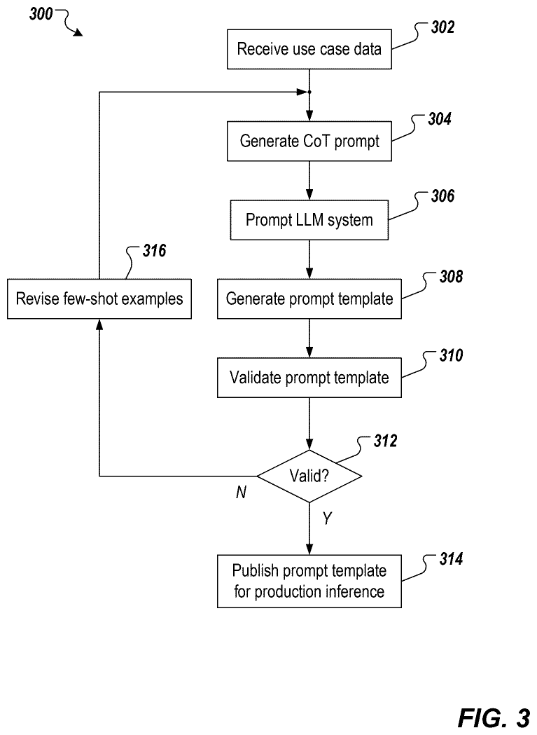

FIG. 3 depicts an example process 300 that can be executed in accordance with implementations of the present disclosure. In some examples, the example process 300 is provided using one or more computer-executable programs executed by one or more computing devices.

Use case data is received (302) and a CoT extraction prompt is generated (304). For example, and as described in detail herein, the prompt generation module 202 of FIG. 2 receives a CoT extraction prompt template from the CoT extraction prompt template store 210 and use case data from the use case data store 212, and populates placeholders of the CoT extraction prompt template with use case data. The LLM system is prompted (306) and an inference prompt template is generated (308). For example, and as described in detail herein, the prompting module 204 prompts the LLM of the LLM system 220, which processes the CoT generation prompt and returns the CoT script 230 in response to the CoT generation prompt. The prompt template generation module 206 receives partial prompt template corresponding to the use case from the partial prompt template store 214 and populates the partial prompt template with the CoT 230 to generate the inference prompt template.

The inference prompt template is validated (310). For example, and as described in detail herein, an accuracy of the inference prompt template can be determined based on prompting using validation data, where accuracy can be determined as the number of matches of a response set that correspond to matches of a set of results of the validation data.

It is determined whether the inference prompt template is valid (312). For example, and as described in detail herein, the accuracy can be compared to a threshold accuracy (e.g., 90%, 95%, 100%) to determine whether the accuracy meets (e.g., is equal to or greater than) the threshold accuracy. If the accuracy meets the threshold accuracy, the inference prompt template is determined to be valid. If the accuracy does not meet the threshold accuracy, the inference prompt template is determined to not be valid. If the inference prompt template is valid, the inference prompt template is published for production inference (314). For example, and as described in detail herein, in production inference, the inference prompt template is used in an enterprise workflow to perform tabular data matching. For example, the inference prompt template can be populated with production data (e.g., data tables) to provide an inference prompt for tabular data matching by the LLM. If the inference prompt template is not valid, few-shot examples are revised (316) and example process 300 loops back. For example, and as described in detail herein, a revised CoT extraction prompt can be generated using a set of few-shot examples that is different than the set of few-shot examples used in a previous iteration. The CoT script is generated, as described above, and validation is again performed before release for production inference.

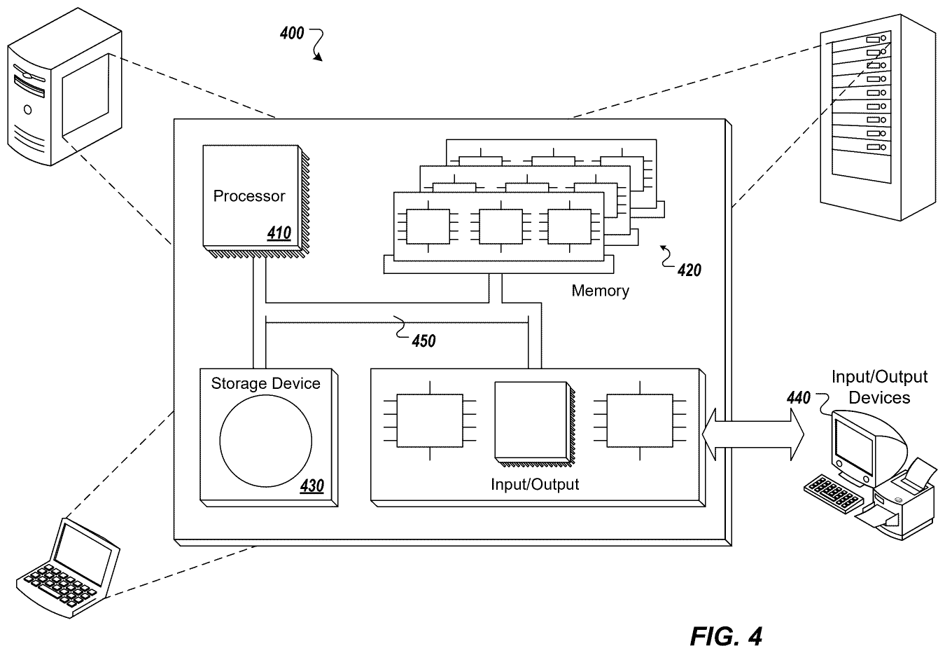

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for chain-of-thought (CoT) prompting of large language models (LLMs) for tabular data matching, the method being executed by one or more processors and comprising:
receiving use case data descriptive of a use case that includes tabular data matching, the use case data comprising process data, task data, table schema data, and a set of few-shot examples;
populating a CoT extraction prompt template using the use case data to provide a CoT extraction prompt;
prompting a LLM using the CoT extraction prompt;
receiving, from the LLM, a CoT script responsive to the CoT extraction prompt;
generating an inference prompt template using the CoT script; and
deploying the inference prompt template for production inference.

2. The method of claim 1, wherein production inference comprises:
populating the inference prompt template with production data comprising a set of tables to provide an inference prompt;
prompting the LLM using the inference prompt;
receiving an inference result from the LLM; and
executing at least one task of a workflow in response to the inference result.

3. The method of claim 1, the tabular data matching comprises matching a query entity represented in a row of a first table to one or more target entities represented in respective rows of a second table.

4. The method of claim 1, wherein deploying the inference prompt template for production inference is executed in response to determining that the inference prompt template is valid.

5. The method of claim 4, wherein the inference prompt template is determined to be valid in response to determining that an accuracy of results generated using the inference prompt template meets a threshold accuracy.

6. The method of claim 1, wherein the table schema data describes fields of columns of each of a first table and a second table storing records that are to be matched by the LLM.

7. The method of claim 1, wherein at least a portion of the use case data comprises an image representative of the use case.

8. A non-transitory computer-readable storage medium coupled to one or more processors and having instructions stored thereon which, when executed by the one or more processors, cause the one or more processors to perform operations for chain-of-thought (CoT) prompting of large language models (LLMs) for tabular data matching, the operations comprising:
receiving use case data descriptive of a use case that includes tabular data matching, the use case data comprising process data, task data, table schema data, and a set of few-shot examples;
populating a CoT extraction prompt template using the use case data to provide a CoT extraction prompt;
prompting a LLM using the CoT extraction prompt;
receiving, from the LLM, a CoT script responsive to the CoT extraction prompt;
generating an inference prompt template using the CoT script; and
deploying the inference prompt template for production inference.

9. The non-transitory computer-readable storage medium of claim 8, wherein production inference comprises:
populating the inference prompt template with production data comprising a set of tables to provide an inference prompt;
prompting the LLM using the inference prompt;
receiving an inference result from the LLM; and
executing at least one task of a workflow in response to the inference result.

10. The non-transitory computer-readable storage medium of claim 8, the tabular data matching comprises matching a query entity represented in a row of a first table to one or more target entities represented in respective rows of a second table.

11. The non-transitory computer-readable storage medium of claim 8, wherein deploying the inference prompt template for production inference is executed in response to determining that the inference prompt template is valid.

12. The non-transitory computer-readable storage medium of claim 11, wherein the inference prompt template is determined to be valid in response to determining that an accuracy of results generated using the inference prompt template meets a threshold accuracy.

13. The non-transitory computer-readable storage medium of claim 8, wherein the table schema data describes fields of columns of each of a first table and a second table storing records that are to be matched by the LLM.

14. The non-transitory computer-readable storage medium of claim 8, wherein at least a portion of the use case data comprises an image representative of the use case.

15. A system, comprising:
a computing device; and
a computer-readable storage device coupled to the computing device and having instructions stored thereon which, when executed by the computing device, cause the computing device to perform operations for chain-of-thought (CoT) prompting of large language models (LLMs) for tabular data matching, the operations comprising:
receiving use case data descriptive of a use case that includes tabular data matching, the use case data comprising process data, task data, table schema data, and a set of few-shot examples,
populating a CoT extraction prompt template using the use case data to provide a CoT extraction prompt,
prompting a LLM using the CoT extraction prompt,
receiving, from the LLM, a CoT script responsive to the CoT extraction prompt,
generating an inference prompt template using the CoT script, and
deploying the inference prompt template for production inference.

16. The system of claim 15, wherein production inference comprises:
populating the inference prompt template with production data comprising a set of tables to provide an inference prompt;
prompting the LLM using the inference prompt;
receiving an inference result from the LLM; and
executing at least one task of a workflow in response to the inference result.

17. The system of claim 15, the tabular data matching comprises matching a query entity represented in a row of a first table to one or more target entities represented in respective rows of a second table.

18. The system of claim 15, wherein deploying the inference prompt template for production inference is executed in response to determining that the inference prompt template is valid.

19. The system of claim 15, wherein the inference prompt template is determined to be valid in response to determining that an accuracy of results generated using the inference prompt template meets a threshold accuracy.

20. The system of claim 15, wherein the table schema data describes fields of columns of each of a first table and a second table storing records that are to be matched by the LLM.
